(19) United States
(12) Patent Application Publication
(10) Pub. No.: US 2025/0096485 A1
(43) Pub. Date: Mar. 20, 2025

(54) Wideband Directional Antenna System With Minimized Volumetric Signature

(71) Applicant: Fractal Antenna Systems, Inc., Bedford, MA (US)

(72) Inventors: Nathan Cohen, Belmont, MA (US); Joseph Theil, Belmont, MA (US)

(73) Assignee: Fractal Antenna Systems, Inc., Bedford, MA (US)

(21) Appl. No.: 18/889,972

(22) Filed: Sep. 19, 2024

Related U.S. Application Data
(60) Provisional application No. 63/583,624, filed on Sep. 19, 2023.

(51) Int. Cl. H01Q 21/28; H01Q 1/36; H01Q 11/08; H01Q 19/30

(52) U.S. Cl. CPC H01Q 21/28; H01Q 1/36; H01Q 11/08; H01Q 19/30

(57) ABSTRACT

Systems, circuits, apparatus, and methods provide directional antenna suites that allow unprecedented wideband directional antenna performance within a small volumetric region. The antenna suites include multiple antennas each covering a different operational frequency band. An antenna system can include a frame housing a number of separate antennas used for the antenna suite (ensemble); the separate antennas can include one or more helical or spiral antennas; other types of antennas may be included, e.g., Yagi antenna and/or fractal Yagi antenna.

### RELATED APPLICATIONS

This application claims the benefit of and priority to U.S. Provisional Application No. 63/583,624, filed Sep. 19, 2023, and entitled “Wideband Directional Antenna System with Minimized Volumetric Signature,” the entire content of which is incorporated herein by reference.

### BACKGROUND

Antenna suites-groupings of antennas, with different individual antennas of a grouping covering different respective frequency spectrum—are used to allow radiofrequency (RF) communication over multiple frequency bands. A base station is a prime example of an application of an antenna suite (a.k.a., antenna ensemble). Prior antenna suites have been encumbered by interaction or interference of the antennas with each other. This interference is typically caused by near-field interactions from mutual coupling and formation of evanescent surface waves. Thus, in prior antenna suites, such proximity has typically prevented the desired performance of an antenna suite within a small confined volume, effectively limiting the smallest size or footprint of the antenna suite.

To obtain the desired performance, prior antenna suites typically were limited by how close antennas could be to one another. As a result, to cover a wide spectrum or positions of same large volumetric arrangements of multiple antenna suites were commonly required.

### SUMMARY

Aspects, examples, and embodiments of the present disclosure are directed to and include systems, circuits, apparatus, and methods providing wireless electrical power and/or communication signal transmission with channel redundancy.

One general aspect of the present disclosure includes an antenna systems having an antenna suite (plurality of antennas). The antenna system can include a frame defining an enclosed volume defined by three orthogonal dimensions, where at least one dimension is a maximum dimension; and a plurality of antennas disposed within the enclosed volume, where each antenna of the plurality of antennas is directional, where each antenna is configured to operates over a different passband, and where the plurality of antennas includes a lowest-frequency antenna having a lowest-frequency passband including a lowest frequency, where the lowest frequency defines a longest operation wavelength of the plurality of antennas; where the enclosed volume has a maximum dimension in any direction that is less than, e.g., one-quarter of the longest wavelength of the lowest-frequency passband. Other embodiments of this aspect may include corresponding computer systems, apparatus, and computer programs recorded on one or more computer storage devices, each configured to perform actions of related methods, e.g., RF communication according to one or more known wireless communication standards and/or facilitating location of RF sources within range of the antenna suite.

Implementations may include one or more of the following features. The antenna system where the plurality of antennas includes a plurality of helical antennas. The plurality of helical antennas is configured for an end-fire radiation mode. One or more of the plurality of helical antennas is right-handed. One or more of the plurality of helical antennas is left-handed. Each adjacent pair of antennas of the plurality of antennas is separated by a desired/designed separation distance, e.g., of less than ⅛, 1/10, 1/12, or 1/15 of an operational wavelength of one of the antennas of the adjacent pair, respectively. The plurality of antennas includes at least five antennas. The plurality of antennas can be configured such that in operation the antennas are substantially decoupled from one another (in other words have little or minimal mutual coupling). The antenna system may include transmission circuitry configured to supply each of the plurality of antennas with RF energy for transmission. The antenna system may include reception circuitry configured to receive RF energy from one or more target RF sources within range of the plurality of antennas. The antenna system may include processing circuitry configured to produce an output signal indicative of a location of one or more RF targets within range of the plurality of antennas. Implementations of the described techniques may include hardware, a method or process, or computer software on a computer-accessible medium.

Another general aspect of the present disclosure includes a method of making an antenna system including an antenna suite. The method can include providing a frame defining an enclosed volume; and providing a plurality of antennas within the enclosed volume, where the plurality of antennas includes a plurality of helical antennas. Each antenna of the plurality of antennas can be configured to be directional, each antenna can be configured to operates over a different passband, and the plurality of antennas can include a lowest-frequency antenna having a lowest-frequency passband including a lowest frequency, where the lowest frequency defines a longest operation wavelength of the plurality of antennas; where the enclosed volume has a maximum dimension that is less than one-quarter of the cube of the longest wavelength of the lowest-frequency passband.

Implementations may include one or more of the following features. The method where the plurality of helical antennas is configured for an end-fire radiation mode. Each adjacent pair of antennas of the plurality of antennas cam be separated by a separation distance of, e.g., less than ⅛, 1/10, 1/12, or 1/15 of an operational wavelength of one of the antennas of the adjacent pair, respectively. The plurality of antennas can include at least five antennas in some embodiments. The plurality of antennas may be configured such that in operation the antennas are substantially decoupled from one another. The method may include providing transmission circuitry configured to supply each of the plurality of antennas with RF energy for transmission. The method may include providing reception circuitry configured to receive RF energy from one or more target RF sources (targets, e.g., cell phones or other RF sources) within range of the plurality of antennas. The method may include providing processing circuitry configured to produce an output signal indicative of a location of one or more RF targets within range of the plurality of antennas.

Embodiments and implementations of the noted aspect(s) can include a system of one or more computers or processing systems that can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform actions, e.g., as described herein or related to such described actions.

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the present disclosure, which is susceptible of many embodiments. What follows is illustrative, but not exhaustive, of the scope of the present disclosure.

### BRIEF DESCRIPTION OF THE DRAWINGS

The manner and process of making and using the disclosed embodiments may be appreciated by reference to the figures of the accompanying drawings. In the figures like reference characters refer to like components, parts, elements, or steps/actions; however, similar components, parts, elements, and steps/actions may be referenced by different reference characters in different figures. It should be appreciated that the components and structures illustrated in the figures are not necessarily to scale, emphasis instead being placed upon illustrating the principals of the concepts described herein. Furthermore, embodiments are illustrated by way of example and not limitation in the figures, in which:

FIGS. 1A-1D show different views of an example antenna system including a directional antenna suite in accordance with the present disclosure;

FIG. 2 is a diagram showing steps in an example method of fabricating of an antenna system including a directional antenna suite in accordance with the present disclosure; and

FIG. 3 shows an example computing system in accordance with the present disclosure.

### DETAILED DESCRIPTION

The features and advantages described herein are not all-inclusive; many additional features and advantages will be apparent to one of ordinary skill in the art in view of the drawings, specification, and claims. Moreover, it should be noted that the language used in the specification has been selected principally for readability and instructional purposes, and not to limit in any way the scope of the inventive subject matter. The subject technology is susceptible of many embodiments. What follows is illustrative, but not exhaustive, of the scope of the subject technology.

Aspects, examples, and embodiments of the present disclosure are directed to and include systems, circuits, apparatus, and methods providing directional antenna suites (groups or pluralities of antennas) that allow unprecedented wideband directional antenna performance within a small volumetric region.

As noted previously, prior antenna suites have been encumbered by interaction of the antennas with each other, caused by near field interactions from mutual coupling and formation of evanescent surface waves. Such proximity, previously for prior art systems, prevented the desired performance of an antenna suite within a small confined volume. The desire for performance, conversely, limited how close antennas could be to one another, thereby forcing large volumetric arrangements of multiple antenna suites, to cover a wide spectrum or positions of same. In contrast, embodiments of the present disclosure minimize these interactions and use geometrically loaded and/or fractal elements to shrink the size of the antennas as well as to allow them to be placed closer together. The volumetric signature (volume size) of embodiments of the present disclosure is thus far smaller than that of prior art systems.

Mutual coupling, as a major constraint on antennas placed in close proximity of one another, has required prior art antenna ensembles, or suites, to be spaced over moderate distances, for example a ½ wavelength of one antennas operational passband, to curtail mutual coupling issues. As such, the tradeoff thus becomes one of antenna performance versus volume. In contrast, embodiments of the present disclosure can utilize miniaturization and polarization diversity and right angle placement to curtail (spoil) mutual coupling between antennas.

For example, some embodiments of the present invention can include a 400 MHz fractal antenna, placed at a right angle to a 1200 MHz miniaturized helix, which configuration curtails (facilitates spoiling of) mutual coupling between antennas. Some embodiments of the present disclosure can incorporate miniature helices (helix) of opposite polarizations. In some embodiments, fractal elements used in antennas cut down the size and allows closer placement of adjacent antenna to curtail (spoil) mutual coupling.

By choosing geometrically shaped (e.g., geometrically loaded) antenna elements and/or fractal antenna elements, in part, and placing these various antenna elements near each other, the coupling can be minimized and evanescent regimes of proximity-very close spacing—may be approached but not infiltrated. This has not been previously accomplished, in the prior art, for volume minimization. Furthermore, the minimized coupling can be used to achieve antenna phasing by changing the antenna element sizes in a way that offsets the reactive change caused by the proximity and minimizes those element's resonances at higher frequencies that are in the operational range of other antennas in the antenna suite.

Elements may also be placed at right angles while still allowing for directional phasing. One antenna may be on a different side of another within a volumetric form factor.

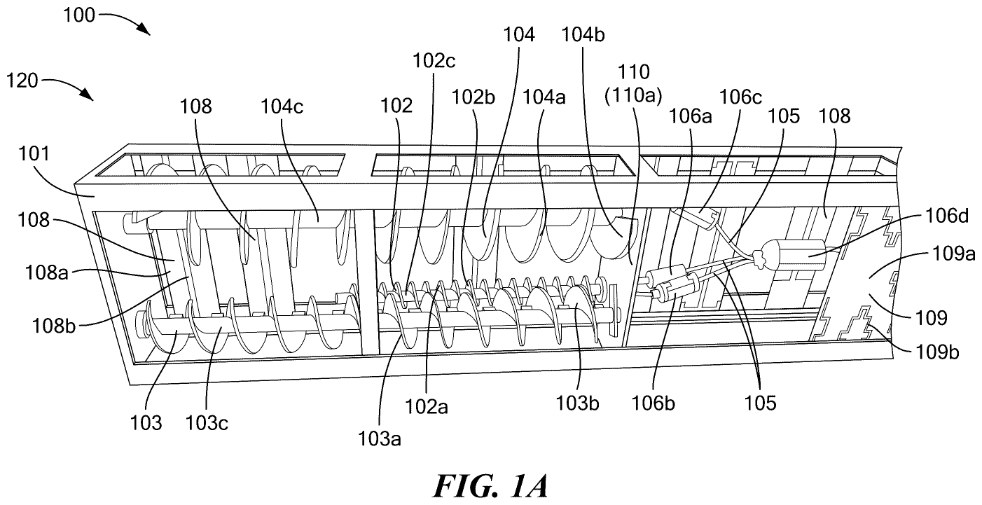

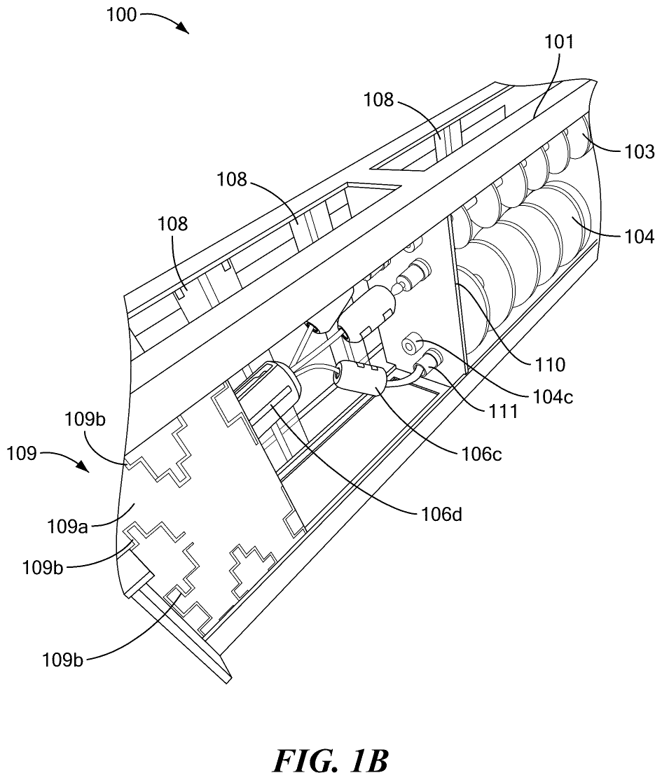

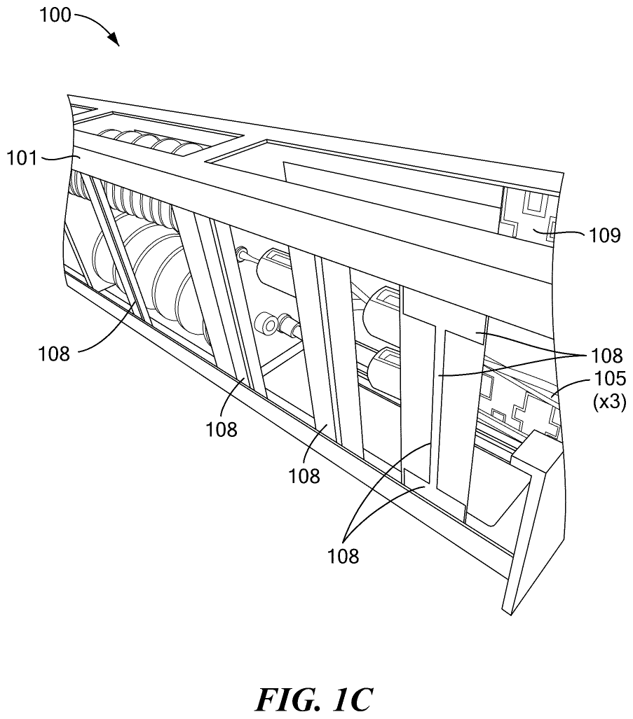

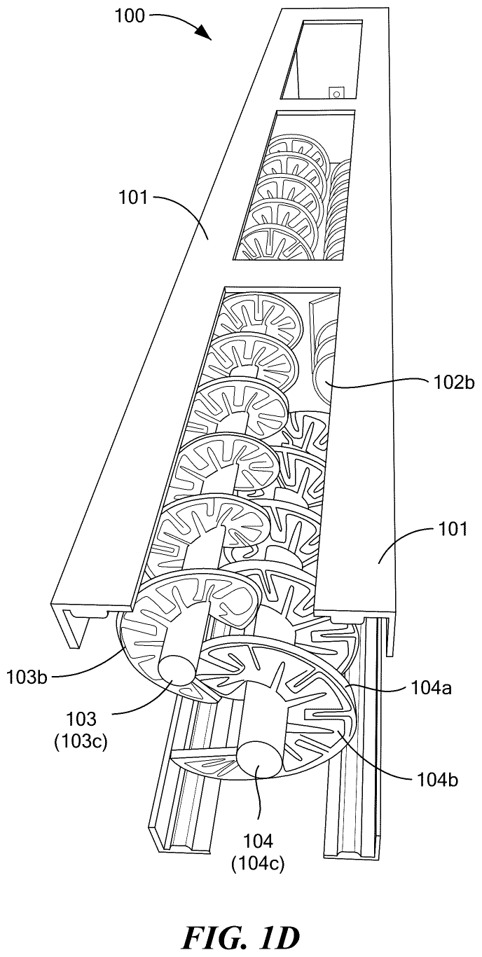

FIGS. 1A-1D show different views of an example antenna system 100 including a directional antenna suite 120 in accordance with the present disclosure. Antenna system 100 can include a frame 101 housing a number of separate antennas used for the antenna suite (ensemble); the separate antennas can include one or more helical or spiral antennas, e.g., spiral antennas 102, 103, and 104; other types of antennas may (optionally) be included, e.g., Yagi antenna 108 and fractal Yagi antenna 109, as explained in further detail below.

FIG. 1A shows a perspective side view of antenna system 100. Antenna system 100 includes a frame 101 defining an enclosed volume (a.k.a., enclosure volume) in which the antenna suite (ensemble) 120, with helical antennas 102-104 and Yagi antennas 108-109, is housed/mounted.

Each of the helical antennas 102-104 may include multiple turns (shown as 102a-104a, respectively) with helical or spiral conductive elements (conductors configured as helices or helix) 102b-104b, respectively, forming turns about a central element aligned along a longitudinal axis 102c-104c, respectively. Each helix turn can include a conductor having a design, e.g., a crank-line meander design, a fractal pattern (using any suitable fractal generator shape) executed in an annulus of substrate and galvanically connected to make a multi turn coil. In some embodiments, suitable fractal shapes used for the helical conductive elements can be as described in Applicant's co-owned U.S. Pat. Nos. 6,476,766, and 7,750,856, the entire content of each of which is incorporated herein by reference.

Each of the helical antennas 102-104 is configured for operation over a different frequency band. Any suitable material(s) can be used for the frame, e.g., plastic, composite, insulated metal(s), etc. Any suitable material(s) may be used for the helical conductive elements, e.g., copper, copper containing alloys, etc.

Yagi antenna 108 can include multiple substrates 108a, each with a radiative element 108b. The substrates 108a can be spaced at desired locations for a Yagi configuration. Any suitable material(s) may be used for the substrates, e.g., PCB material such as FR-4, FR-5, etc. Any suitable material(s) may be used for the radiative elements 108b, e.g., copper, copper containing alloys, etc.

Yagi antenna 109 includes a substrate 109a (e.g., a PCB) having multiple fractal loading elements 109b. The substrate with fractal elements (a.k.a., fractal circuit board) can include two elements configured at right angles, adjacent to one another, as shown. This configuration produces a novel two element Yagi antenna that has minimal mutual coupling, to the other antennas.

Feed lines 105 are shown conveying RF energy/power to and from the antennas of the antenna suite 120. One or more RF chokes 106a-d (e.g., ferrite collars) may be employed with the feed lines 105, as shown.

FIG. 1B shows a close up perspective view of one end of antenna system 100. Mounting platform 110 is shown, on which the helical antennas can be mounted, e.g., by press-fitting each central element 104c through an aperture in platform 110). Groundplane 110a (shown in FIG. 1A) may be mounted to platform 110.

FIG. 1C shows another perspective view of antenna system 100. Substrates 108 of Yagi antenna 108 are shown. The spacing between the substrates can be adjusted as desired, e.g., for a particular frequency band.

FIG. 1D shows a perspective end view of antenna system 100, with one piece of frame 101 removed (to better show internal structure). Helical conductive elements 102b-104b are shown having crank-line meandering patterns. Different patterns, e.g., including one or more fractal patterns, may be used for elements 102b-104b in other embodiments.

In an exemplary embodiment, the antenna suite 120 of system 100 includes shrunken helices (helix) for frequency bands including 5 GHZ, 2.4 GHZ, and 1.2 GHz, a loaded Yagi antenna 108 for a band including 900 MHZ, and a fractal Yagi antenna for a band including 400 MHz. The antenna suite 120 can accordingly be operational from about 400 MHz to about 6 GHz in a form factor of 40.5 cm by 10.3 cm by 5.7 cm as an example, with the antenna suite operational over wavelengths from about 70 cm to about 5 cm. A conventional version of a prior art antenna suite covering the same range of operational frequencies would require a volume eight (8) times or more larger to achieve the desired gain performance. In some embodiments, the antenna suite can cover one or more (including all) of the following frequency bands: 430 MHz; 700-799 MHz; 800-960 MHz; 1200-1300 MHz; 1600-1900 MHz; 2200-2700 MHZ; 3300-3500 MHz; and 5000-5900 MHz.

The antenna suite 120 (a.k.a., ensemble, collection, group, or plurality) allows for a modular arrangement in which the ensemble fits into a compact volume (e.g., rectangular volume) that is much smaller than prior art devices. Embodiments of the present disclosure can, accordingly, be treated as portable or plug-in devices, for example in an RF jammer gun assembly (housed on a ground station or an air vehicle), used for jamming other antennas such as used on drones or other aero vehicles.

The frame (defining the enclosure or enclosed volume) acts as an antenna mount for the ensemble. Each antenna may be fed separately with each having a feedline choked, for example with ferrite collars.

A variety of directional antenna techniques may be employed, for example parasitic (Yagi) arrangements, end fire helices, and so on. Spiral antennas can be configured to operate in end fire mode, e.g., by having the circumference of the spiral antenna being equal to an operational wavelength of the antenna.

Of course, the configuration—e.g., number of antennas, type(s) and sizing—of antenna suites (ensembles) may be varied within the scope of the present disclosure.

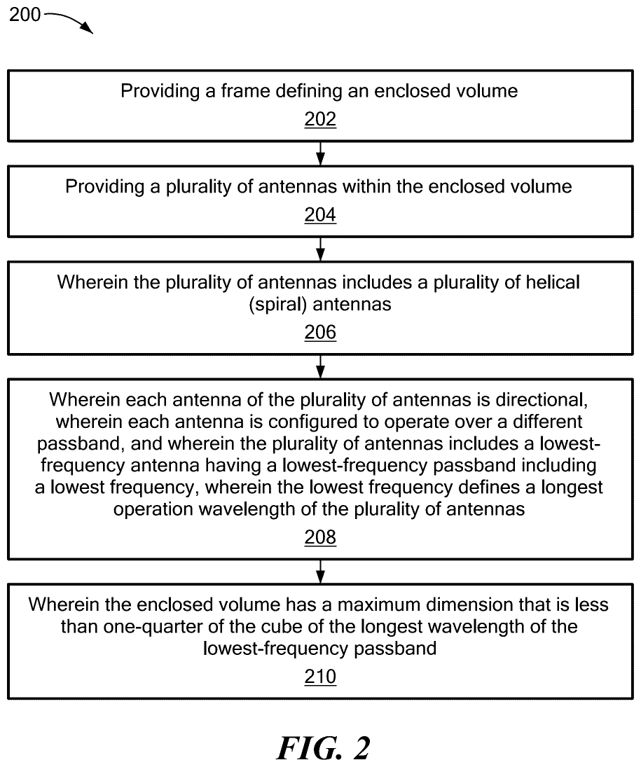

FIG. 2 is a diagram showing steps in an example method of fabricating an antenna system including a directional antenna suite in accordance with the present disclosure. As shown, method 200 can include providing a frame defining an enclosed volume (a.k.a., enclosure volume), as described at 202. A plurality of antennas can be provided within the enclosed volume, as described at 204. The plurality of antennas can include a plurality of helical (helix, helice, or spiral) antennas, as described at 206.

Each antenna of the plurality of antennas can be configured as a directional antenna, each antenna can be configured to operate over a different passband, and the plurality of antennas can include a lowest-frequency antenna having a lowest-frequency passband including a lowest frequency, wherein the lowest frequency defines a longest operation wavelength of the plurality of antennas, as described at 208. The enclosed volume can have a maximum dimension (in any direction) that is less than one-quarter of the longest wavelength of the lowest-frequency passband, as described at 210.

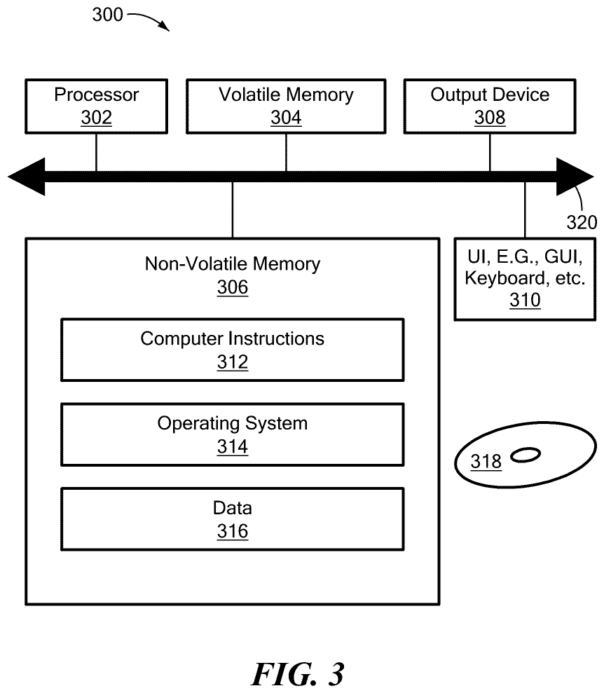

FIG. 3 shows an example computing system 300 in accordance with the present disclosure. System 300 (and/or similar or equivalent systems) can perform all or at least a portion of the processing, e.g., steps in the algorithms and methods as described herein. Such processing can include but is not limited to: determining locations of RF targets within range of one or more antennas of an antenna suite, e.g., such as shown and described for FIG. 1 or a similar antenna system according to the present disclosure; and/or performing processing needed for RF communications using any of various well known communication standards, e.g., 5G, 6G, 4G, etc. and the like.

The computer system 300 can includes a processor 302, a volatile memory 304, a non-volatile memory 306 (e.g., hard disk), an output device 308 and a user input or interface (UI) 310, e.g., graphical user interface (GUI), a mouse, a keyboard, a display, and/or any common user interface, etc. The non-volatile memory (non-transitory storage medium) 306 stores computer instructions 312 (a.k.a., machine-readable instructions or computer-readable instructions) such as software (computer program product), an operating system 314 and data 316. In one example, the computer instructions 312 are executed by the processor 302 out of (from) volatile memory 304. In one embodiment, an article/apparatus 318 (e.g., a storage device or medium such as a hard disk, an optical disc, magnetic storage tape, optical storage tape, flash drive, etc.) includes or stores the non-transitory computer-readable instructions.

Processing may be implemented in hardware, software, or a combination of the two. Processing may be implemented in computer programs executed on programmable computers/machines that each includes a processor, a storage medium or other article of manufacture that is readable by the processor (including volatile and non-volatile memory and/or storage elements), and optionally at least one input device, and one or more output devices. Program code may be applied to data entered using an input device or input connection (e.g., port or bus) to perform processing and to generate output information.

The system 300 can perform processing, at least in part, via a computer program product, (e.g., in a machine-readable storage device), for execution by, or to control the operation of, data processing apparatus (e.g., a programmable processor, a computer, or multiple computers). Each such program may be implemented in a high-level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate, e.g., perform processing facilitating RF target location and/or communication under any of known RF (wireless) air interface protocols/standards.

Processing may be performed by one or more programmable processors executing one or more computer programs to perform the functions of the system. All or part of the system may be implemented as special purpose logic circuitry, e.g., an FPGA (field programmable gate array) and/or an ASIC (application-specific integrated circuit).

Various embodiments of the concepts, systems, devices, structures, and techniques sought to be protected are described above with reference to the related drawings. Alternative embodiments can be devised without departing from the scope of the concepts, systems, devices, structures, and techniques described. For example, in some embodiments, the number of complete revolutions or turns of the spiral conductor (conductive element) of a helical antenna—where one revolution or turn corresponds to the length of the pitch of the helical antenna—may have a whole number or a fractional number, e.g., 1.5, 2.5, 1.75, 1.8, 2.25, 5, 6.5, 8.8, etc. Moreover, while embodiments of the present disclosure have been described above and shown in the accompanying figures as having frames with generally rectangular shapes, frames with other alternate shapes (e.g., elliptical, square, spherical, etc.) may be used within the scope of the present disclosure.

It is noted that various connections and positional relationships (e.g., over, below, adjacent, etc.) may be used to describe elements and components in the description and drawings. These connections and/or positional relationships, unless specified otherwise, can be direct or indirect, and the described concepts, systems, devices, structures, and techniques are not intended to be limiting in this respect. Accordingly, a coupling of entities can refer to either a direct or an indirect coupling, and a positional relationship between entities can be a direct or indirect positional relationship.

As an example of an indirect positional relationship, positioning element “A” over element “B” can include situations in which one or more intermediate elements (e.g., element “C”) is between elements “A” and elements “B” as long as the relevant characteristics and functionalities of elements “A” and “B” are not substantially changed by the intermediate element(s).

Also, the following definitions and abbreviations are to be used for the interpretation of the claims and the specification. The terms “comprise,” “comprises,” “comprising,” “include,” “includes,” “including,” “has,” “having,” “contains” or “containing,” or any other variation are intended to cover a non-exclusive inclusion. For example, an apparatus, a method, a composition, a mixture, or an article, which includes a list of elements is not necessarily limited to only those elements but can include other elements not expressly listed or inherent to such apparatus, method, composition, mixture, or article.

Additionally, the term “exemplary” means “serving as an example, instance, or illustration.” Any embodiment or design described as “exemplary” is not necessarily to be construed as preferred or advantageous over other embodiments or designs. The terms “one or more,” and “at least one” may indicate any integer number greater than or equal to one, i.e., one, two, three, four, etc.; those terms, however, may refer to fractional numbers/values where context admits, e.g., a number of turns or revolutions of the spiral (helical) conductive element or conductor (around a longitudinal axis) of a helical antenna may be a plurality (set or group) that includes a fractional value, e.g., 2.75, 3.5, 4.6, etc. The term “plurality” can include any integer or fractional (e.g., decimal) number greater than one. The term “connection” can include an indirect connection and/or a direct connection.

References in the specification to “embodiments,” “one embodiment, “an embodiment,” “an example embodiment,” “an example,” “an instance,” “an aspect,” etc., indicate that the embodiment described can include a particular feature, structure, or characteristic, but every embodiment may or may not include the particular feature, structure, or characteristic. Moreover, such phrases do not necessarily refer to the same embodiment. Further, when a particular feature, structure, or characteristic is described in connection with an embodiment, it may affect such feature, structure, or characteristic in other embodiments whether explicitly described or not.

Relative or positional terms including, but not limited to, the terms “upper,” “lower,” “right,” “left,” “vertical,” “horizontal, “top,” “bottom,” and derivatives of those terms relate to the described structures and methods as oriented in the drawing figures. The terms “overlying,” “atop,” “on top, “positioned on” or “positioned atop” mean that a first element, such as a first structure, is present on a second element, such as a second structure, where intervening elements such as an interface structure can be present between the first element and the second element. The term “direct contact” means that a first element, such as a first structure, and a second element, such as a second structure, are connected without any intermediary elements.

Use of ordinal terms such as “first,” “second,” “third,” etc., in the claims to modify a claim element does not by itself connote any priority, precedence, or order of one claim element over another, or a temporal order in which acts of a method are performed but are used merely as labels to distinguish one claim element having a certain name from another element having a same name (but for use of the ordinal term) to distinguish the claim elements.

The terms “approximately” and “about” may be used to mean within +20% of a target (or nominal) value in some embodiments, within plus or minus (+) 10% of a target value in some embodiments, within +5% of a target value in some embodiments, and yet within +2% of a target value in some embodiments. The terms “approximately” and “about” may include the target value. The term “substantially equal” may be used to refer to values that are within +20% of one another in some embodiments, within +10% of one another in some embodiments, within +5% of one another in some embodiments, and yet within +2% of one another in some embodiments.

The term “substantially” may be used to refer to values that are within +20% of a comparative measure in some embodiments, within +10% in some embodiments, within +5% in some embodiments, and yet within +2% in some embodiments. For example, a first direction that is “substantially” perpendicular to a second direction may refer to a first direction that is within +20% of making a 90° angle with the second direction in some embodiments, within +10% of making a 90° angle with the second direction in some embodiments, within +5% of making a 90° angle with the second direction in some embodiments, and yet within +2% of making a 90° angle with the second direction in some embodiments.

The disclosed subject matter is not limited in its application to the details of construction and to the arrangements of the components set forth in the following description or illustrated in the drawings. The disclosed subject matter is capable of other embodiments and of being practiced and implemented in various ways.

Also, the phraseology and terminology used in this patent are for the purpose of description and should not be regarded as limiting. As such, the conception upon which this disclosure is based may readily be utilized as a basis for the designing of other structures, methods, and systems for carrying out the several purposes of the disclosed subject matter. Therefore, the claims should be regarded as including such equivalent constructions as far as they do not depart from the spirit and scope of the disclosed subject matter.

Although the disclosed subject matter has been described and illustrated in the foregoing exemplary embodiments, the present disclosure has been made only by way of example. Thus, numerous changes in the details of implementation of the disclosed subject matter may be made without departing from the spirit and scope of the disclosed subject matter.

Accordingly, the scope of this patent should not be limited to the described implementations but rather should be limited only by the spirit and scope of the following claims.

All publications and references cited in this patent are expressly incorporated by reference in their entirety.

What is claimed is:

1. An antenna system comprising:
a frame defining an enclosed volume defined by three orthogonal dimensions, wherein at least one dimension is a maximum dimension; and
a plurality of antennas disposed within the enclosed volume, wherein each antenna of the plurality of antennas is directional, wherein each antenna is configured to operates over a different passband, and wherein the plurality of antennas includes a lowest-frequency antenna having a lowest-frequency passband including a lowest frequency, wherein the lowest frequency defines a longest operation wavelength of the plurality of antennas;
wherein the enclosed volume has a maximum dimension in any direction that is less than one-quarter of the longest wavelength of the lowest-frequency passband.

2. The antenna system of claim 1, wherein the plurality of antennas includes a plurality of helical antennas.

3. The antenna system of claim 2, wherein the plurality of helical antennas is configured for an end-fire radiation mode.

4. The antenna of claim 3, wherein one or more of the plurality of helical antennas is right-handed.

5. The antenna system of claim 3, wherein one or more of the plurality of helical antennas is left-handed.

6. The antenna system of claim 1, wherein each adjacent pair of antennas of the plurality of antennas is separated by a separation distance of less than 1/15 of an operation wavelength of one of the antennas of the adjacent pair, respectively.

7. The antenna system of claim 1, wherein the plurality of antennas includes at least five antennas.

8. The antenna system of claim 1, wherein the plurality of antennas is configured such that in operation the antennas are substantially decoupled from one another.

9. The antenna system of claim 1, further comprising transmission circuitry configured to supply each of the plurality of antennas with RF energy for transmission.

10. The antenna system of claim 1, further comprising reception circuitry configured to receive RF energy from one or more target RF sources within range of the plurality of antennas.

11. The antenna system of claim 1, further comprising processing circuitry configured to produce an output signal indicative of a location of one or more RF targets within range of the plurality of antennas.

12. A method of making an antenna system including an antenna suite, the method comprising:
providing a frame defining an enclosed volume; and
providing a plurality of antennas within the enclosed volume, wherein the
plurality of antennas includes a plurality of helical antennas;
wherein each antenna of the plurality of antennas is directional, wherein each antenna is configured to operates over a different passband, and wherein the plurality of antennas includes a lowest-frequency antenna having a lowest-frequency passband including a lowest frequency, wherein the lowest frequency defines a longest operation wavelength of the plurality of antennas;
wherein the enclosed volume has a maximum dimension in any direction that is less than one-quarter of the longest wavelength of the lowest-frequency passband.

13. The method of claim 12, wherein the plurality of helical antennas is configured for an end-fire radiation mode.

14. The method of claim 12, wherein each adjacent pair of antennas of the plurality of antennas is separated by a separation distance of less than 1/15 of an operation wavelength of one of the antennas of the adjacent pair, respectively.

15. The method of claim 12, wherein the plurality of antennas includes at least five antennas.

16. The method of claim 12, wherein the plurality of antennas is configured such that in operation the antennas are substantially decoupled from one another.

17. The method of claim 12, further comprising providing transmission circuitry configured to supply each of the plurality of antennas with RF energy for transmission.

18. The method of claim 12, further comprising providing reception circuitry configured to receive RF energy from one or more target RF sources within range of the plurality of antennas.

19. The method of claim 12, further comprising providing processing circuitry configured to produce an output signal indicative of a location of one or more RF targets within range of the plurality of antennas.
